(19) United States
(12) Patent Application Publication
(10) Pub. No.: US 2012/0240447 A1
(43) Pub. Date: Sep. 27, 2012

(54) DECOY SUPPORT

(76) Inventor: Albert H. Gurner, III, Salisbury, NC (US)

(21) Appl. No.: 13/427,743

(22) Filed: Mar. 22, 2012

Related U.S. Application Data
(60) Provisional application No. 61/466,953, filed on Mar. 24, 2011.

(51) Int. Cl. A01M 31/06; B23P 11/00; B23P 17/00; F16M 11/00

(52) U.S. Cl. 43/2; 248/176.1; 29/525.11; 29/407.1

(57) ABSTRACT

The present invention provides a motorized decoy support for positioning and imparting movement to decoy bodies such as game bird decoy bodies. The decoy support includes a stake that includes a housing positioned at one end of the stake. A power-supply unit is configured to be received within the housing. A shaft for transmitting motion extends from the power-supply unit and includes a tip configured to engage a decoy body and the tip is configured to emit light.

### PRIORITY

This is a non-provisional application that claims priority from U.S. Provisional Pat. App. No. 61/466,953 that was filed on Mar. 24, 2011 and that is incorporated herein in its entirety.

### FIELD OF THE INVENTION

The invention relates generally to movable decoys and more specifically to a motorized support for a decoy for simulating motion of turkeys and the like.

### BACKGROUND OF THE INVENTION

Decoys for luring game birds are an important part of hunting. In particular, decoys are useful for particular species of birds such as turkey or geese. Certain characteristics of a decoy are especially important for luring a predetermined species. These characteristics can include size, position, coloration, silhouette, surrounding context, and motion. Conventional decoys are configured to embodiment at least one of these characteristics.

One problem with known decoys for game birds is that they do not replicate motion in a manner that is sufficiently natural to lure wary species.

Another problem with conventional decoys that do employ motion is that they can be mechanically complex. It is believed that as a result, such decoys are susceptible to malfunctioning. Such failures in the field compromise the decoys ability to attract game.

Another problem with conventional decoys is that they might be difficult to set up prior to a hunt. Decoys are often set up in less than ideal weather conditions. Such conditions can include low or no light due to time of day, tree cover, cloud cover, or other obstructions to light.

Another problem with conventional motorized decoys is that they may be expensive. Excessive cost of a decoy can have substantial impact on a hunt, particularly when several decoys are deployed.

### SUMMARY OF THE INVENTION

Accordingly, the present invention provides a motorized support for a decoy configured to address the foregoing problems. More specifically, the present invention provides a support configured to retain a motor and decoy such that the decoy can be easily transported, positioned in the field, and activated to attract game birds such as turkeys.

According to one embodiment of the present invention, there is provided a motorized decoy support for positioning and imparting movement to decoy bodies such as game bird decoy bodies. The decoy support includes a stake that includes a housing positioned at one end of the stake. A power-supply unit is configured to be received within the housing. A shaft for transmitting motion extends from the power-supply unit and includes a tip configured to engage a decoy body and the tip is configured to emit light.

According to one aspect of the present invention, the tip includes a light emitting diode.

According to one aspect of the present invention, the tip is configured to enhance its visibility in low-light conditions.

According to one aspect of the present invention, the tip is coated with a light emitting substance.

According to one aspect of the present invention, the light emitting substance is phosphorescent.

According to another embodiment of the present invention, there is provided a method for installing a decoy for a game bird. The method includes the steps of: A) providing a stake that includes a housing positioned at one end of the stake, a power-supply unit configured to be received within the housing, a shaft for transmitting motion extending from the power-supply unit, wherein the shaft includes a tip configured to engage a decoy body and the tip is configured to emit light; B) providing a decoy body and a nut configured to secure the decoy body to the tip; C) pushing the stake into ground; D) positioning the power supply unit within the housing; E) aligning the tip with an opening defined in the decoy body; F) aligning the tip with the nut; and G) securing the body to the tip and thus to the motor and stake by securing the nut to the tip.

According to one aspect of the present invention, the method includes the further step of activating the power unit.

According to one aspect of the present invention, the method includes the further step of visually determining the location of the tip relative to the opening with the aid of light emitted from the tip.

According to one aspect of the present invention, the method includes the further step of visually determining the location of the tip relative to the nut with the aid of light emitted from the tip.

According to one embodiment of the present invention, there is provided a decoy for luring game birds. The decoy includes a stake that includes a housing positioned at one end of the stake; a power-supply unit configured to be received within the housing; a shaft for transmitting motion extending from the power-supply unit; and a body configured to simulate a game bird. The shaft includes a tip configured to engage the body and the tip is configured to emit light.

According to one aspect of the present invention, the decoy further comprising graphics position on the stake that realistically simulate game bird legs.

According to one aspect of the present invention, the power-supply unit is an electric motor.

According to one aspect of the present invention, the motor is powered by a D battery.

### BRIEF DESCRIPTION OF THE DRAWINGS

For a fuller understanding of the nature and objects of the present invention, reference should be made to the following detailed description taken in connection with the accompanying drawings, wherein:

FIG. 1 is a side view of a partially-cutaway game bird decoy positioned on a post configured in accordance with one embodiment of the preferred invention;

FIG. 2 is an exploded view of the partially-cutaway game bird decoy and the post according to the embodiment shown in FIG. 1; and

FIG. 3 is an exploded view of a partially-cutaway game bird decoy and a post according to an alternative embodiment of the preferred invention shown in FIG. 1.

### DETAILED DESCRIPTION OF THE PREFERRED EMBODIMENTS

Embodiments of the present invention are directed to a support configured to retain a motor and decoy such that the decoy can be easily transported, positioned in the field, and activated to attract game birds such as turkeys. The support is also configured to be easily and economically manufactured and maintained.

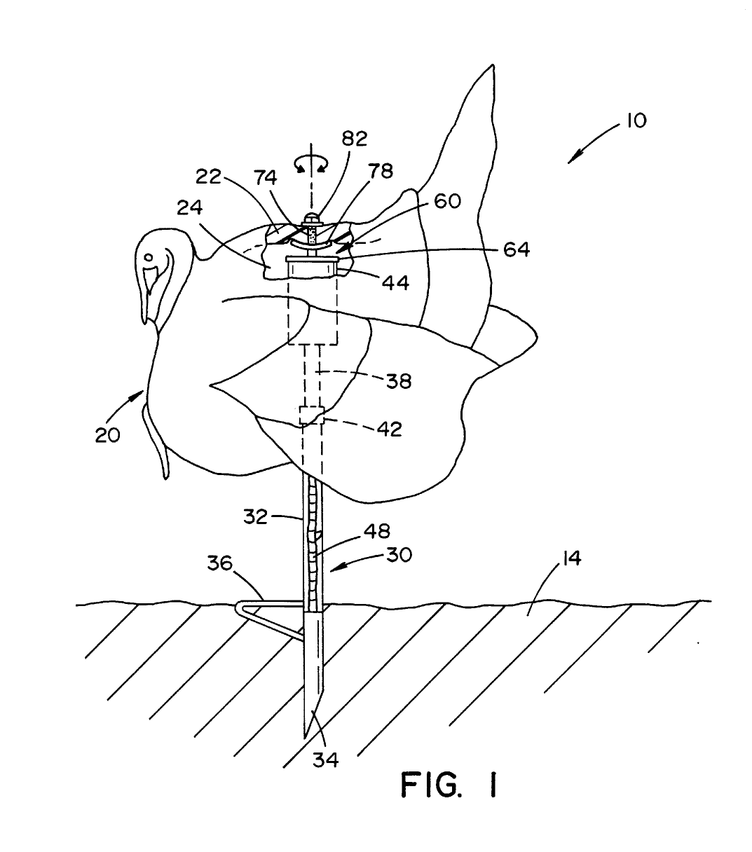

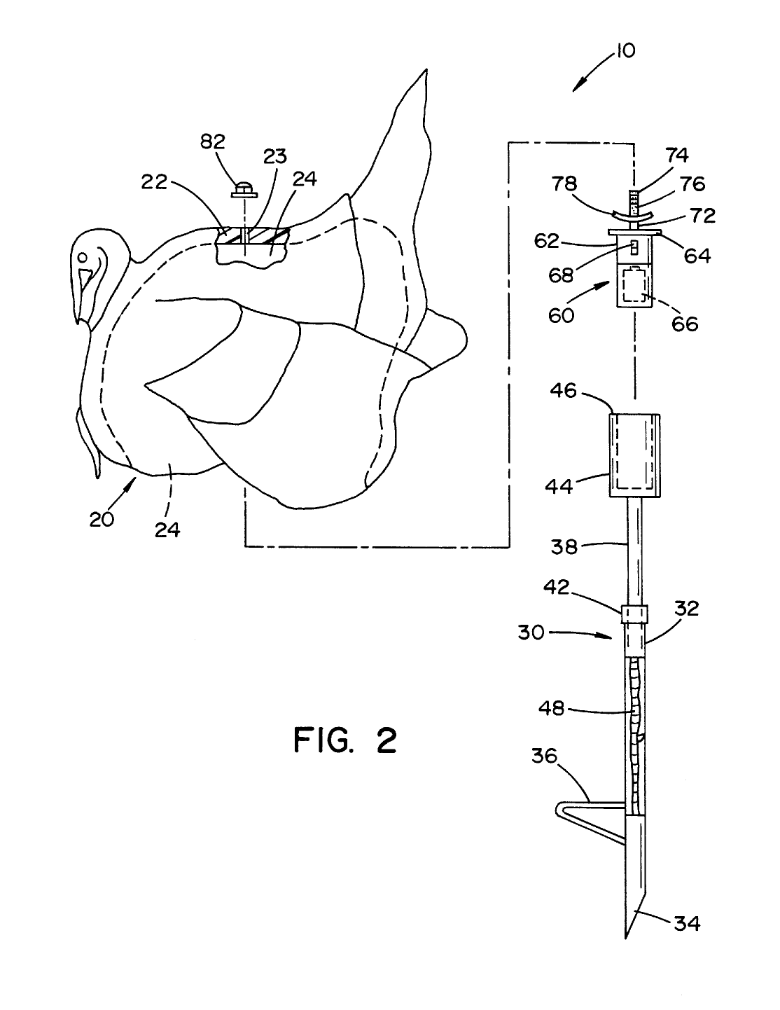

Referring to FIGS. 1 and 2, in accordance with an embodiment of the invention, a motorized decoy 10 includes a stake 30 that is configured to be inserted into ground 14 such that a decoy body 20 is supported. Body 20 includes a wall 22 that defines a cavity 24. An opening 23 is formed in wall 22 such that an attaching tip 74 of stake 30 can extend therethrough.

In addition to attaching tip 74, stake 30 also includes a shaft 32 that has a ground tip 34. Ground tip 34 is positioned on an end of shaft 32. Ground tip 34 is configured to be retained within ground 14 and in the illustrated embodiment ground tip 34 is shaped to better enable insertion into ground 14. A step 36 extends substantially perpendicularly away from shaft 32 and is configured to provide a leverage position such that tip 34 of shaft 32 can be pushed into ground 14. In this regard, a user would place their foot on step 36.

Shaft 32 has an exterior surface that has graphics 48 positioned thereon. In the illustrated embodiment, graphics 48 are chosen to mimic the legs of a turkey. It should be appreciated that graphics 48 could be chosen to mimic a portion of a turkey or other game bird in a realistic manner or in an abstract manner. In this regard, graphics 48 and the exterior surface shape and contour of shaft 32 are generally chosen to be perceived by a game bird such that the appearance of shaft 32 does not spook, and even assists in attracting, the game bird to a desired location.

Continuing to refer to FIGS. 1 and 2, a rod 38 is configured to be received within shaft 32 and extend therefrom such that the overall length of stake 30 can be adjusted to a predetermined length. Rod 38 is retained in position relative to shaft 32 by a collet 42 or other retention device. Stated another way, stake 30 is configured to be telescoping and the length of stake 30 can be fixed by operation of collet 42.

Rod 38 includes a housing 44 that is formed in an end of rod 38 positioned away from shaft 32. Housing 44 is substantially cup-shaped in the illustrated embodiment and includes a rim 46. Housing 44 is configured to receive a power unit 60. Power unit 60 is configured to cause body 20 to rotate or otherwise move. In the illustrated embodiment, power unit 60 is an electric motor 62. Motor 62 includes a annular flange 64 engages rim 46 of housing 44. In the preferred embodiment motor 62 powered by a battery 66 but in other embodiments it can be powered by photovoltaic cells or a supply of alternating current from a generator or power grid. Preferably, battery 66 is a D battery. A switch 68 is provided such that power to motor 62 from battery 66 or other power source can be regulated. It should be appreciated that switch 68 can be activated manually or that circuitry can be provided such that power unit 60 is remotely activated by wire or wirelessly.

In alternative embodiments, power unit 60 is configured to store potential energy by mechanical means such as a spring or elastic band. In these embodiments the retained energy is converted to kinetic energy with the storage means is released. In some embodiments an escapement is configured to regulate the released of energy such that the motion of body 20 is within predetermined speed or other limits.

Motor 62 includes a motor shaft 72 that extends therefore such that motion and power can be transmitted from motor 62 via shaft 72 to body 20. Shaft 72 extends from motor 62 to attaching tip 74. Attaching tip 74 threaded for receiving a nut 82 that is configured to securely engage wall 22 of body 20 to a securement 78. Securement 78 is configured to secure body 20 relative to the shaft such that body 20 is configured to move with shaft 72. By way of example and not limitation, securement 78 can include the following: a claw, a prong, a spike, high friction pad or gasket, and a combination thereof. Securement 78 is configured such that it feature that it engages shaft 72 with a complementary shape in a manner that limits or prohibits motion of securement 78 relative to shaft 72. Likewise, in a preferred embodiment power unit 60 and housing 44 are configured such that power unit 60 cannot rotate relative to housing 44. Such configuration can include overall shape or a complimentary key and slot.

A light emitting element 76 is positioned on attaching tip 74. Light emitting element 76 can be an electrically powered light source such as a light emitting diode or LED or incandescent bulb. In a preferred embodiment, light emitting element 76 is phosphorescent. Alternatively light emitting element 76 can be chemi-luminescent. Light emitting element 76 is configured to provide for location of tip 74 by a user during the process of attaching nut 82 to tip 74 to secure body 20 to power unit 60 and ultimately to stake 30. It has been found that light emitting element 76 can be sufficiently bright to aid in placing body 20 on stake 30 during low light conditions yet not be so bright as to give away the position of the hunter or otherwise affect the hunt. In short, light emitting element 76 is a glow-in-the dark feature.

The present invention can be better understood by a description of the operation thereof. Motorized decoy 10 can be transported by a hunter to the site of the hunt disassembled such that body 20, stake 30, and power unit 60 are not in the final configuration. When the desired location is reached, the user pushes stake 30 into the ground using step 36. The location is chosen with regard to the immediate landscape and other decoys, if any. After stake 30 is inserted into ground 14, rod 38 is positioned such that attaching tip 74 is a predetermined distance from the ground 14. Collet 42 is secured such that rod 38 is held substantially in positioned relative to shaft 32. In this manner, stake 30 is positioned at a predetermined length.

Power unit 60 is then positioned in housing 44. Light emitting element 76 is activated if necessary and body 20 is positioned such that attaching tip 74 extends through opening 23 of body 20. Nut 82 is placed onto attaching tip 74 such that securement 78 is engaged with body 20 and body 20 is secured to stake 30. Switch 68 is then activated such that power unit 60 provides motion to body 20. In this manner motorized decoy 10 is initiated and installed such that can game birds can be attracted thereto.

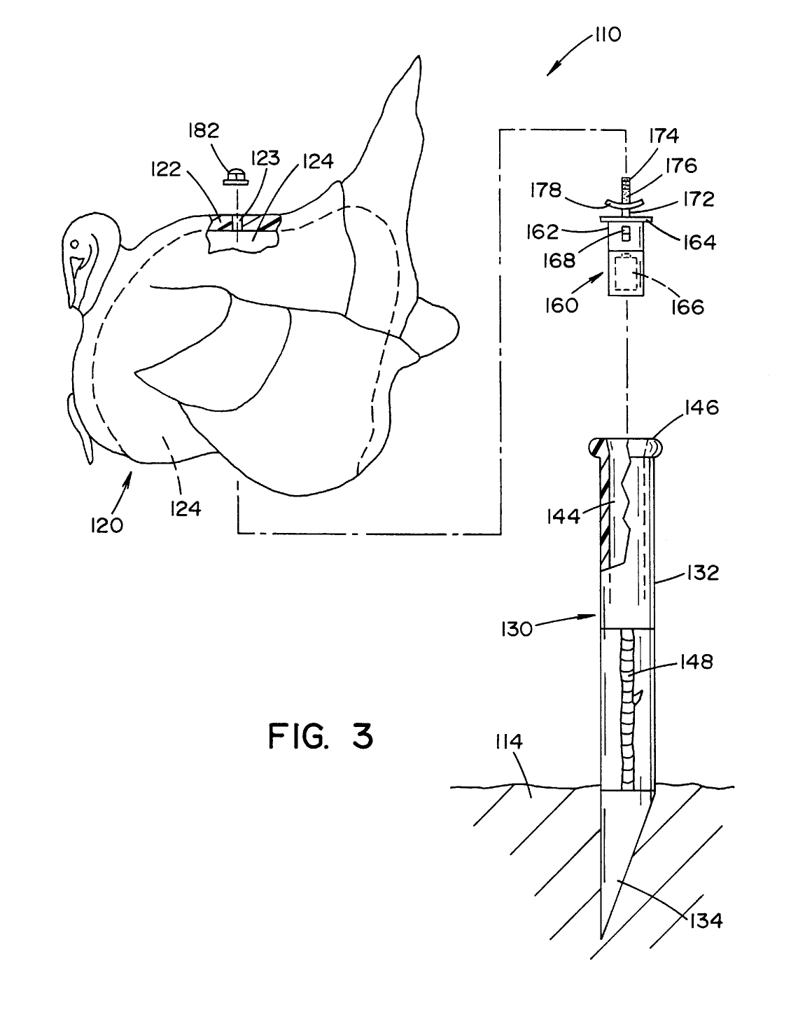

Referring now to an alternative embodiment as shown in FIG. 3, one-hundred-series reference numbers are used to designate elements of a motorized decoy 110. Elements in the alternative embodiment having like ones portions in common with elements in the embodiment described are analogous to and generally similar to those elements except where otherwise noted.

Continuing to refer to the alternative embodiment shown in FIG. 3, a motorized decoy 110 includes a stake 130 that is configured to be inserted into ground 114 such that a decoy body 120 is supported. Body 120 includes a wall 122 that defines a cavity 124. An opening 123 is formed in wall 122 such that an attaching tip 174 of stake 130 can extend there-through. Positioned opposite attaching tip 174 is a ground tip 134. Ground tip 134 is positioned on an end of shaft 132. Ground tip 134 is configured to be retained within ground 114 and to better enable insertion into ground 114.

Stake 130 has an exterior surface that has graphics 148 positioned thereon. In the illustrated embodiment, graphics 148 are chosen to mimic the legs of a turkey. It should be appreciated that graphics 148 could be chosen to mimic a portion of a turkey or other game bird in a realistic manner or in an abstract manner. In this regard, graphics 148, and the exterior surface shape and contour of stake 130, are generally chosen to be perceived by a game bird such that the appearance of stake 132 does not spook, and even assists in attracting, the game bird to a desired location.

Stake 130 includes a housing 144 that is positioned away from tip 134 and includes a rim 146. As shown in FIG. 3, housing 144 has defines an exterior profile that generally matches and continues the exterior profile of stake 130. Housing 144 is configured to receive a power unit 160 that is substantially similar to power unit 60 and can be understood from a description thereof where corresponding numbers of the ones series and of the one-hundred series should be understood as being substantially similar.

The present invention can be better understood by a description of the operation of motorized decoy 10 as shown in FIGS. 1 and 2. The operation of the alternate embodiment shown in FIG. 3 and designated by 100 series reference numbers. Motorized decoy 10 can be transported by a hunter to the site of the hunt disassembled such that body 20, stake 30, and power unit 60 are not in the final configuration. When the desired location is reached, the user pushes stake 30 into the ground using step 36. The location is chosen with regard to the immediate landscape and other decoys, if any. After stake 30 is inserted into ground 14, rod 38 is positioned such that attaching tip 74 is a predetermined distance from the ground 14. Collet 42 is secured such that rod 38 is held substantially in positioned relative to shaft 32. In this manner, stake 30 is positioned at a predetermined length.

Power unit 60 is then positioned in housing 44. Switch 68 is activated such that power unit 60 provides motion to body 20 and light emitting element 76 is activated if necessary. It should be appreciated that the step of activating switch 68 can occur after body 20 is attached to power unit 60. To attach body 20 to power unit 60, the user of the motorized decoy 10 then visually determines the location of tip 74 and aligns it with opening 23. It is believed that such alignment is aided because of the increased visibility provided by light emitting element 76. Body 20 is positioned such that attaching tip 74 extends through opening 23 of body 20. Nut 82 is threaded or otherwise placed onto attaching tip 74 such that securement 78 is engaged with body 20 and body 20 is secured to stake 30. Visual location of tip 74 relative to body 20 and nut 82 is critical to efficient installation of decoy 10. In early morning hours, or other conditions when visibility is low, light emitting element 76 generates enough light such that tip 74 can be located and properly aligned with opening 23 and nut 82. But not so much light that the hunt is adversely affected.

In this manner motorized decoy 10 is initiated and installed such that can game birds can be attracted thereto. Once the apparatus is activated, it will produce the natural motions and rotations of a strutting male wild turkey. The battery operated revolving stake apparatus must be switched on at time of decoy set-up and will rotate continuously at 2 to 4 revolutions per minute. The battery operated revolving stake apparatus may be used in conjunction with a variety of hollow body molded decoys and is not limited to the male wild turkey decoy.

Generally body 20 will rotated between about 2 and about 4 revolutions per minute. The presence or absence of wind during while decoy 10 is activated can affect the motion of body 20. Generally the presence of wind can further enhance motion realism with additional movement and inconsistent rotation.

To summarize, this invention includes a manual switch for on/off activation of a single battery operated revolving decoy stake designed to support and impart natural motions to a turkey decoy. The revolving stake apparatus is removable and can be attached to the body of a turkey decoy. Once the apparatus is activated, it will produce the natural motions and rotations of a strutting male wild turkey. The battery operated revolving stake apparatus must be switched on at time of decoy set-up and will rotate continuously at 2 to 4 revolutions per minute. The battery operated revolving stake apparatus may be used in conjunction with a variety of hollow body molded decoys and is not limited to the male wild turkey decoy. The plastic/PVC base stake, which holds the battery operated revolving motor is photo realistically enhanced with authentic turkey legs to fool the wariest of male wild turkeys. The tip of the extension shaft has a Glow-In-The Dark Feature allowing easy set up during early morning low-light conditions.

It is believed that features of the present invention represent improvements over conventional decoys and decoy supports. In this regard, a suitable battery 66 has been tested to demonstrate an operation life has been tested for continuous, non-stop use over 20 hours. In addition, in a preferred embodiment, the support stake 30 weighs just over 1 pound such that it is lightweight and not bulky. It is believed that under some circumstances, motorized decoy 10 can be set up in 15 seconds. It is also believed that the illustrated embodiments described above can be produced at low costs such that a motorized decoy according to the present invention is more economical that a conventional motorized decoy.

While the present invention has been illustrated and described with reference to preferred embodiments thereof, it will be apparent to those skilled in the art that modifications can be made and the Invention can be practiced in other environments without departing from the spirit and scope of the invention, set forth in the accompanying claims.

Having described the invention, the following is claimed:

1. A motorized decoy support for positioning and imparting movement to decoy bodies such as game bird decoy bodies, the decoy support comprising:
a stake that includes a housing positioned at one end of the stake;
a power-supply unit configured to be received within the housing;
a shaft for transmitting motion extending from the power-supply unit;
wherein the shaft includes a tip configured to engage a decoy body and the tip is configured to emit light.

2. A motorized decoy support according to claim 1, wherein the tip includes a light emitting diode.

3. A motorized decoy support according to claim 1, wherein the tip is configured to enhance its visibility in low-light conditions.

4. A motorized decoy support according to claim 1, wherein the tip is coated with a light emitting substance.

5. A motorized decoy support according to claim 4, wherein the light emitting substance is phosphorescent.

6. A method for installing a decoy for a game bird, the method comprising the steps of:
providing a stake that includes a housing positioned at one end of the stake, a power-supply unit configured to be received within the housing, a shaft for transmitting motion extending from the power-supply unit, wherein the shaft includes a tip configured to engage a decoy body and the tip is configured to emit light;
providing a decoy body and a nut configured to secure the decoy body to the tip;
pushing the stake into ground;
positioning the power supply unit within the housing;
aligning the tip with an opening defined in the decoy body;
aligning the tip with the nut; and
securing the body to the tip and thus to the motor and stake by securing the nut to the tip.

7. A method for installing a decoy according to claim 6, the method comprising the further step of activating the power unit.

8. A method for installing a decoy according to claim 6, the method comprising the further step of visually determining the location of the tip relative to the opening with the aid of light emitted from the tip.

9. A method for installing a decoy according to claim 6, the method comprising the further step of visually determining the location of the tip relative to the nut with the aid of light emitted from the tip.

10. A decoy for luring game birds, the decoy comprising:
a stake that includes a housing positioned at one end of the stake;
a power-supply unit configured to be received within the housing;
a shaft for transmitting motion extending from the power-supply unit;
a body configured to simulate a game bird;
wherein the shaft includes a tip configured to engage the body and the tip is configured to emit light.

11. The decoy according to claim 10, wherein the decoy further comprising graphics position on the stake that realistically simulate game bird legs.

12. The decoy according to claim 10, wherein the power-supply unit is an electric motor.

13. The decoy according to claim 12, wherein the motor is powered by a D battery.
